(19) United States
(12) Patent Application Publication
(10) Pub. No.: US 2008/0155354 A1
(43) Pub. Date: Jun. 26, 2008

(54) Method and apparatus for collection and comparison of test data of multiple test runs

(76) Inventor: Robert S. Kolman, Allen, TX (US)

Correspondence Address: VERIGY, LTD., IP LEGAL DEPARTMENT, 10100 N. TANTAU AVENUE, CUPERTINO, CA, 95014-2540, US

(21) Appl. No.: 11/642,500

(22) Filed: Dec. 20, 2006

(51) Int. Cl. G06F 11/00

(52) U.S. Cl. 714/45; 714/E11.001

(57) ABSTRACT

Embodiments of the invention include a novel testing apparatus and method that allows presentation and analysis of DUT test data collected over multiple test runs.

### BACKGROUND OF THE INVENTION

The present invention relates generally to computerized presentation and analysis of test data, and more particularly to methods and apparatuses for collecting and comparing test data of devices under test (DUTs) over multiple test runs of DUTs.

Industrial device testers, used for example along a manufacturing line, generate significant amounts of test data. Tester software which controls the tester may interface with a graphical user interface to facilitate input and output of information between the tester and a test operator. The graphical user interface may have capability of presenting test data. Test data may be presented in aggregated form including test data acquired from the testing of individual devices in the test run. Alternatively, test data may be presented in the form of summary test data which summarizes test data over all DUTs in a test run. Test data may also be presented in the form of statistical data calculated based on the raw test data of the test run.

The usefulness of the test data is only as good as the tools that extract meaning from the data. Tools such as statistical process control tools exist which monitor test data and generate warnings or alarms when the collected data is out of specification. These tools, called statistical process control tools, often may also be used to detect trends in a process, for example the increase or decrease of a parameter value over time. Knowledge of out-of-specification measurements and trends may be used to assist test operators in pin-pointing and finding solutions to problems in the testing process.

Current tester software collects test data on a per-test-run basis. One reason for this is that a given tester can test any number of different DUT designs, and the design of the set of DUTs being tested is often different between individual test runs. For a given test run, in which a large number of individual DUTs of a particular common design are to be tested, the tester software must be configured specific to that particular DUT design of the DUTs being tested in the particular test run. Current tester software does not allow presentation and analysis of DUT test data for multiple test runs.

However, comparison of test data, summary data, and statistical data derived from the raw test data across multiple test runs may be useful. For example, comparison of test data over multiple test runs may be used to detect and understand operating characteristics of the tester itself, such as the rate of temperature change over the life of individual manufacturing runs, more failures showing in a given subset of tester resources from manufacturing run to manufacturing run, etc. Comparison of test data over multiple runs may also be used to detect and understand characteristics of the testing process, such as site power failure, replaced tester circuitry, shift change, etc. Accordingly, it would be desirable to have multiple test run data presentation and analysis capability in industrial testing environments.

### SUMMARY OF THE INVENTION

Embodiments of the invention allow the simultaneous presentation of multiple test runs of test data and/or statistics derived from the test data acquired across multiple test runs.

In one embodiment, a test data presentation method includes simultaneously presenting, by a computer, test data associated with multiple different test runs, each test run comprising a set of tests executed by a tester on a plurality of devices under test.

In one embodiment, a computer readable storage medium tangibly embodying program instructions implementing a test data presentation method includes simultaneously presenting, by a computer, test data associated with multiple different test runs, each test run comprising a set of tests executed by a tester on a plurality of devices under test.

In one embodiment, a test system includes a tester which tests a plurality of devices per test run and performs a plurality of test runs, a test data collector which collects and stores test data for the plurality of different test runs, and a test run comparison presentation function which simultaneously presents test data associated with multiple different test runs.

### BRIEF DESCRIPTION OF THE DRAWINGS

A more complete appreciation of this invention, and many of the attendant advantages thereof, will be readily apparent as the same becomes better understood by reference to the following detailed description when considered in conjunction with the accompanying drawings in which like reference symbols indicate the same or similar components, wherein:

FIG. 1 is a perspective view of an automated test system;

FIG. 2 is a block diagram illustrating interaction between a GUI interface and a device under test in the test system of FIG. 1;

FIG. 3 is a block diagram of an embodiment of tester software and its relationship to a tester and a user interface;

FIG. 4 is a window of a graphical user interface;

FIG. 5 is an example Test Run Comparison Selection dialog for a graphical user interface;

FIG. 6 is a window of a graphical user interface illustrating the application of the Test Run Comparison selections shown in FIG. 5;

FIG. 7 is a window of a graphical user interface which presents a plot;

FIG. 8 is a window of a graphical user interface which presents an ordinal plot;

FIG. 9 is a window of a graphical user interface which illustrates presentation of statistics;

FIG. 10 is an example Test Run Compare dialog for a graphical user interface;

FIG. 11 is a window of a graphical user interface which presents a bargraph of the statistical mean capacitance value over test runs;

FIG. 12 is a window of a graphical user interface which presents an ordinal plot of operating temperature over test runs; and

FIG. 13 is a flowchart illustrating an exemplary embodiment of a method for simultaneously presenting test data associated with multiple different test runs.

### DETAILED DESCRIPTION

Embodiments of the invention include a novel testing apparatus and method that allows presentation and analysis of DUT test data collected over multiple test runs.

It is advantageous to define several terms before describing the invention. It should be appreciated that the following definitions are used throughout this application. Where the definition of terms departs from the commonly used meaning of the term, applicant intends to utilize the definitions provided below, unless specifically indicated.
For the purposes of the present invention, the term “test run” refers to a set of tests performed on a plurality of devices under test (DUTs) according to a constant tester configuration over a continuous period of time. DUTs tested by the same tester during a period of time during which no interruption of testing occurs due to reconfiguration of the tester or tests to be executed are considered to belong to the same “test run”. DUTs tested by different testers, or tested at different times between which an interruption of testing occurs due to reconfiguration of the tester or tests to be executed are considered to belong to different “test runs”.

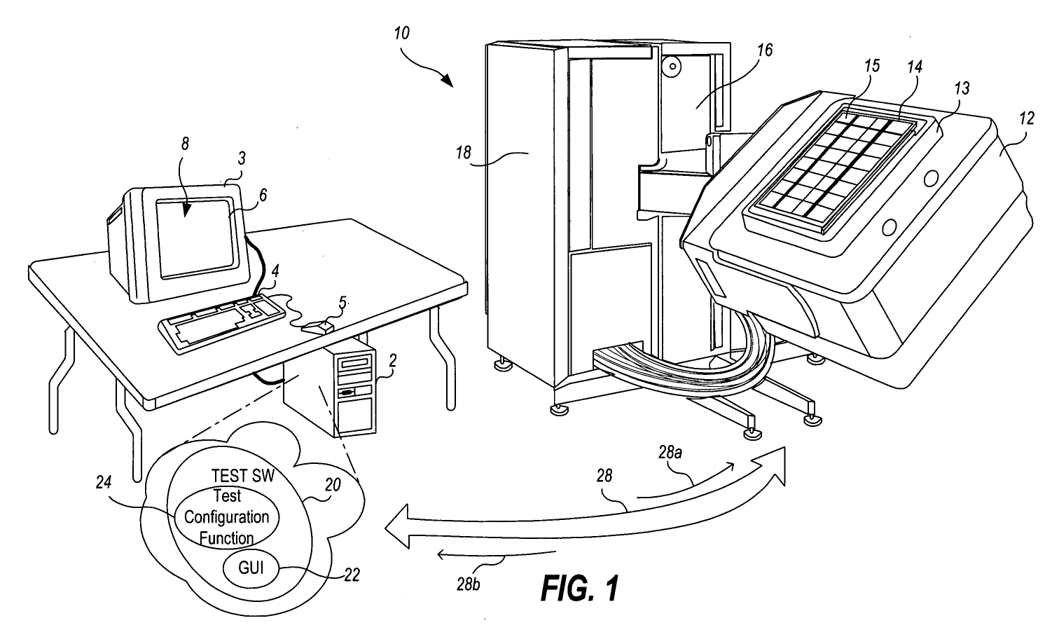

Turning now to the drawings, FIG. 1 is a view of a system including an industrial tester 10. For purposes of illustration, the details of the tester 10 shall be discussed herein in terms of the tester 10 being an Verigy 93000 Systems-on-a-Chip (SOC) Series test system, manufactured by Verigy, Inc., of Palo Alto, Calif. However, it is to be understood that the novel features of embodiments described herein may be applied to any type of tester which tests groups of any type of device in test runs.

The tester 10 comprises a test head 12 for interfacing with and supplying hardware resources to a device under test (DUT) 15, a manipulator 16 for positioning the test head 12, a support rack 18 for supplying the test head 12 with power, cooling water, and compressed air, and a workstation 2.

The test head 12 comprises all the tester electronics, including digital and analog testing capabilities required to test the DUT, such as obtaining test measurements for parameters of interest of the DUTs. The test head 12 is connected to a DUT interface 13. The device under test (DUT) 15 may be mounted on a DUT board 14 which is connected to the tester resources by the DUT interface 13. The DUT interface 13 may be formed of high performance coax cabling and spring contact pins (pogo pins) which make electrical contact to the DUT board 14. The DUT interface 13 provides docking capabilities to handlers and wafer probers (not shown).

The test head 12 may be water cooled. It receives its supply of cooling water from the support rack 18 which in turn is connected by two flexible hoses to a cooling unit (not shown). The manipulator 16 supports and positions the test head 12. It provides six degrees of freedom for the precise and repeatable connection between the test head 12 and handlers or wafer probers. The support rack 18 is attached to the manipulator 16. The support rack 18 is the interface between the test head 12 and its primary supplies (AC power, cooling water, compressed air).

An operator may interact with the tester 10 by way of a computer or workstation (hereinafter collectively referred to as “workstation”). The workstation 2 is the interface between the operator and the test head 12. Tester software 20 may execute on the workstation 2. Alternatively, tester software may execute in the test head 12 or another computer (not shown), where the workstation 2 may access the tester software remotely. In one embodiment, the workstation 2 is a high-performance Unix workstation running the HP-UX operating system or a high-performance PC running the Linux operating system. The workstation 2 is connected to a keyboard 4 and mouse 5 for receiving operator input. The workstation 2 is also connected to a display monitor 3 on which a graphical user interface (GUI) window 8 may be displayed on the display screen 6 of the monitor 3. Communication between the workstation 2 and the test head 12 may be via direct cabling or may be achieved via a wireless communication channel, shown generally at 28.

The tester software 20, which is stored as program instructions in computer memory and executed by a computer processor, comprises test configuration functionality 24 for configuring tests on the tester 10, and for obtaining test results. The tester software 20 also comprises GUI interface 22 which implements functionality for displaying test data. Test data may be in the form of any one or more of raw test data 28b received from the test head 12, formatted test data, summary data, and statistical data comprising statistics calculated based on the raw test data. GUI interface 22 may detect and receive user input from the keyboard 4 and mouse 5, and which generates the GUI window 8 on the display screen 6 of the monitor 3.

The tester software 20 allows download of setups and test data 28a to the test head 12. All testing is carried out by the test head 12, and test results 28b are read back by the workstation 2 and displayed on the monitor 3.

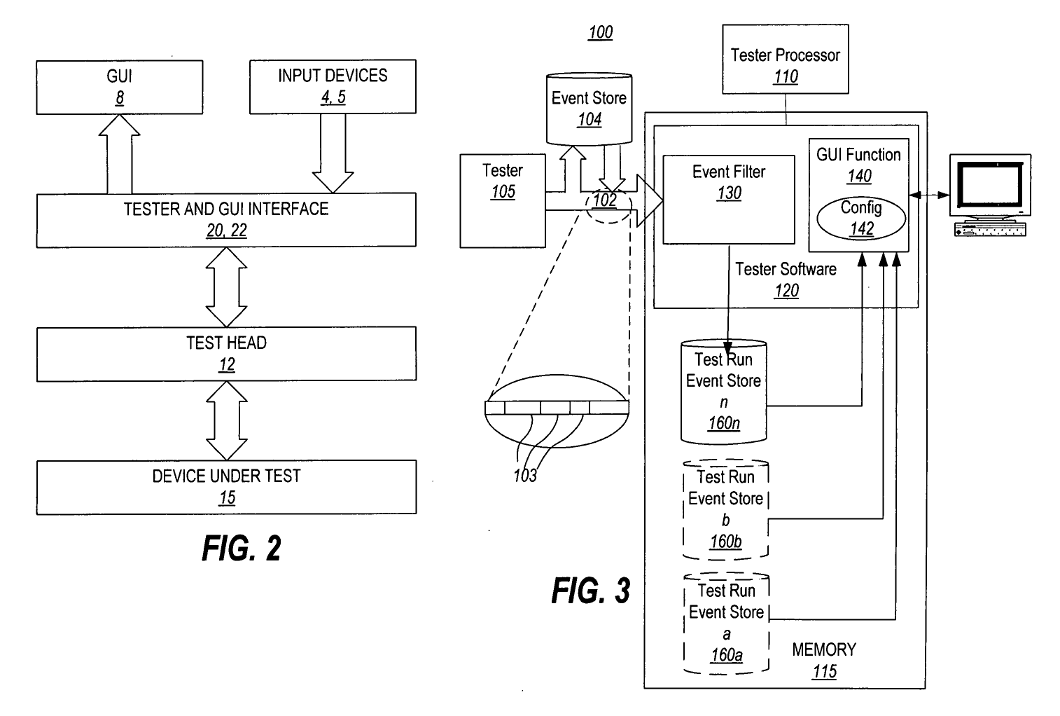

FIG. 2 is a block diagram illustrating the interaction between the GUI interface 8 and DUT 15 in the test system 10 of FIG. 1. As illustrated, the GUI interface 2 presents the GUI window 8 to the operator by rendering a window onto a screen 6 of display 3. The GUI interface 2 receives operator input received from keyboard 4 and mouse 5, sets up, downloads test information and test data, and initiates execution of tests of the DUT 15 by the test head 12. The test head 12 performs tests of the DUT 15 as instructed by the tester software 20 and collects test results. The test results are uploaded from the test head 12 and passed to the GUI interface 2, which updates the GUI window 8 presented on the display 3.

FIG. 3 illustrates an embodiment of tester software and its relationship to a tester and a user interface. As illustrated, a tester 105 is an event-generating system which generates electronic data in the form of events 102. Each event 102 typically comprises a plurality of different pieces of information relating to an item of data. For example, an event 102 may be a measurement event that includes not only a measurement value, but also other information associated with the measurement such as item serial number from which the measurement was made, time of measurement, measurement identifier which indicates the particular measurement made, manufacturing line identifier, tester identifier, test operator identifier, etc. Typically, pieces of information associated with an item of data are packaged into a data packet. The individual pieces of information associated with the item of data may be stored in fields 103. For purposes of convenience, an item of electronic data shall be referred to herein as an “event” 102, and the individual pieces of information associated with the event shall be referred to herein as “fields” 103 of the event. While conceptually an event 102 comprises a number of fields 103, the particular packaging of the fields which make up the event may not be as straightforward as merely appending each field into a fixed length data package. In practice, the individual fields may be interspersed or combined with other fields, and/or may be encrypted, such that only by performing a specific extraction function can the individual field values be extracted from an event. For simplicity of description, fields of an event shall be illustrated as being readily identifiable portions of the data package that makes up the event. However, it is to be understood that the fields are to be extracted from event data using appropriate respective function(s) required for reliable extraction of each of the individual fields.

The tester 105 generates events 102 of various types. For example, tester events 102 may include events types such as a message event type, a measurement event type, a system status event type, and so on. Each event may include a number of event fields 103 each of which includes information associated with the particular event 102. For example, a message event may include an event type field identifying the event as a message event, a time field which identifies the time of the message, a system identifier which identifies the system to which the message applies, a message field which stores the message, etc. A measurement event may include an event type field identifying the event as a measurement event, a time field which identifies the time of the measurement, a system identifier which identifies the system from which the measurement was made, a test identifier which identifies the test type, a measurement value which contains the actual measured value, etc. A system status event may include an event type field identifying the event as a system status event, a time field which identifies the time of the status, a system identifier which identifies the system to which the status applies, a status field which indicates the identified system's status, etc. The types of events and the numbers and sizes of the fields for each event type may vary from system to system.

The events 102 generated by the tester 105 may be stored in an unfiltered event store 104. For example, tester events 102 may be stored in a file formatted according to a particular format standard (such as EDL (Event Description Language) format).

Tester software 120 stored as program instructions in a computer readable memory 115 is executed by a processor 110. Tester software 120 collects information about components of the DUT to be tested and associated parameters to be tested for each component. A GUI function 140 implements configuration dialog functionality 142 which generates a series of dialogues configured to allow an operator to enter configuration information. Configuration information may be information regarding the DUTs to be tested, the tests to be run, the parameters to be tested in each tester, and other user input. Dialog rendering and capture of user input to set up a configuration of the tester is known in the art.

The tester software 120 may include an event filter 130 which may route event data 102 of certain types to a current test run event data store 160n. For example, the event filter 130 may route only events of a measurement type that comprises information about a DUT to the current test run event data store 160n, and not events of a system status type that are relevant only to the tester itself or the testing process. For each test run (a, b, . . . , n) of DUTs tested, a corresponding test run event data store 160a, 160b, . . . , 160n is created and stored in computer readable memory 115. The data store 160a, 160b, . . . , 160n may be stored as files which may be accessed by GUI function 140.

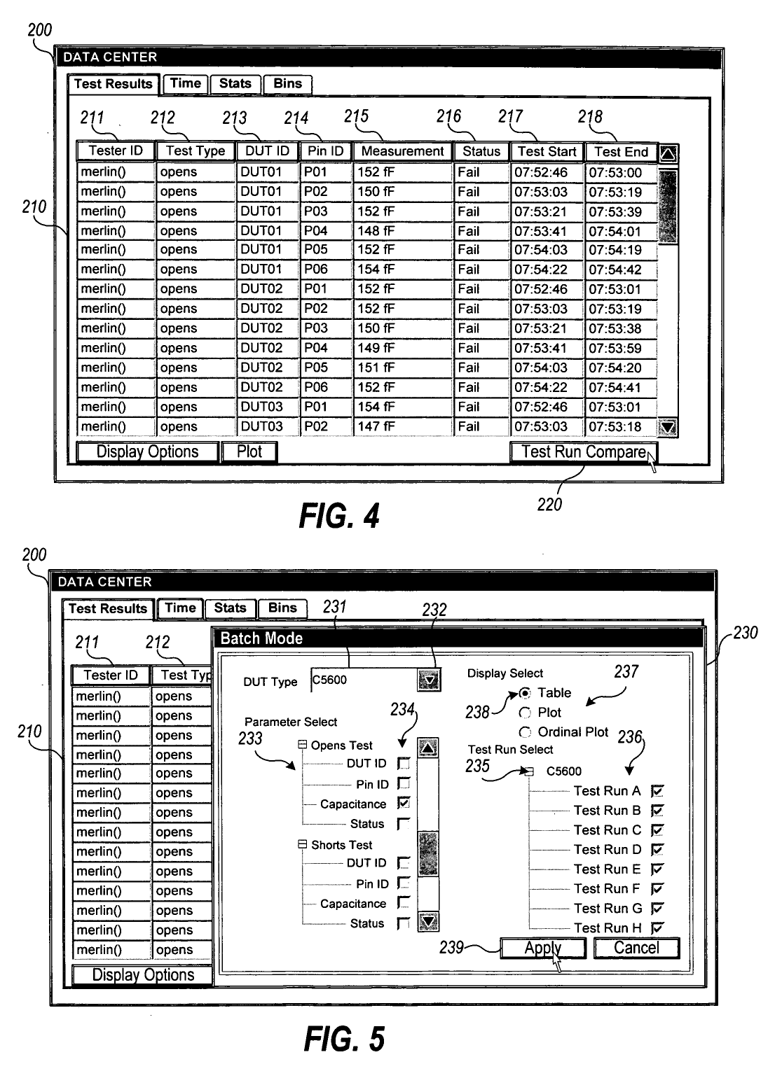

GUI function 140 includes functionality for monitoring user input devices for user input, and for presenting and displaying test data and corresponding summary and/or statistics data. FIG. 4 illustrates an example embodiment of a window 200 that may be presented to a user on a display 3 by the GUI function 140. As illustrated, the window 200 may include a Data Results pane 210 which displays event data according to a default or user-specified format. In the embodiment shown, DUT test data for the currently selected test run is displayed in a tabular format, wherein each column 211 through 218 corresponds to a particular field 103 of a measurement data type event 102. In the example shown, the display configuration is set to display, in columns from left to right, the tester ID 211, test type 212, DUT ID 213, Pin ID 214, measurement value 215, test status 216, test start time 217, and test end time 218.

Test data may be presented in one of two modes—“normal mode” in which only the test data from the current test run is presented, or “test run comparison mode” in which test data from a plurality of different test runs is presented. This display configuration may be set to “normal mode” as a default display configuration, wherein test data from a single selected test run is displayed (for example, as shown in FIG. 4). The display may be switched to “test run comparison mode” by an operator via user interface mechanisms such as a Test Run Comparison button 220 accessible from the window 200. When the Test Run Comparison button 220 is clicked on by a mouse or otherwise activated using means well-known in the art, a Test Run Comparison Selection dialog 230 is displayed to present test run selection options.

In one embodiment, illustrated in FIG. 5, the Test Run Comparison Selection dialog 230 may include a mechanism 231 for selecting a DUT type of interest. In one embodiment, the DUT type selection mechanism 231 is a list box 232 which lists the available DUT types from which to choose. While not necessary for every application, the DUT type selection mechanism 231 may be useful in narrowing down the particular test run event stores 160a, 160b, 160n that contain relevant comparison data. For example, since DUTs of different types typically have different pin configurations and different test setup configurations, it may not make sense or be appropriate to compare the test data from two test runs which test different DUT types. In other cases, it may be useful to compare certain fields (such as test status) over all test runs regardless of DUT type being tested. For example, all test runs may be selected regardless of DUT type to determine a time when the tester began failing all DUTs. The time may then be correlated with an event, possibly external to the tester, such as a site power failure.

The Test Run Comparison Selection dialog 230 may also include a mechanism 233 for selecting one or more test parameters of interest. In one embodiment, the parameter selection mechanism 233 is a list of test types and corresponding parameters collected for the test types. Each parameter may have an associated checkbox 234 which may be checked to instruct the GUI to display and compare the parameter associated with the checked box. Again, while not necessary for every application, the parameter selection mechanism 233 may be useful in narrowing down the particular test run event stores 160a, 160b, 160n that contain relevant comparison data.

The Test Run Comparison Selection dialog 230 may also include a Test Run Selection mechanism 235. In one embodiment, the Test Run Selection mechanism 235 is a list (shown in tree form) of available test runs which contain data relevant to the selected DUT type and selected parameters. Each listed test run has an associated checkbox 236 which may be checked by the operator to select the corresponding test runs to compare.

The Test Run Comparison Selection dialog 230 may also include a Display Mode Selection mechanism 237. In one embodiment, the Display Mode Selection mechanism 237 is a set of radio buttons 238 associated with different modes of display. For example, different display modes may include “table” mode, “plot” mode, “ordinal plot” mode, and more.

The Test Run Comparison Selection dialog 230 may also include an configuration request submit mechanism 239. In the illustrative embodiment, the configuration request submit mechanism 239 is an “Apply” button. When an operator clicks on the Apply button 239, the selections made in the Test Run Comparison Selection dialog 230 are submitted to the GUI 140 for rendering test data according to the applied configuration on the display.

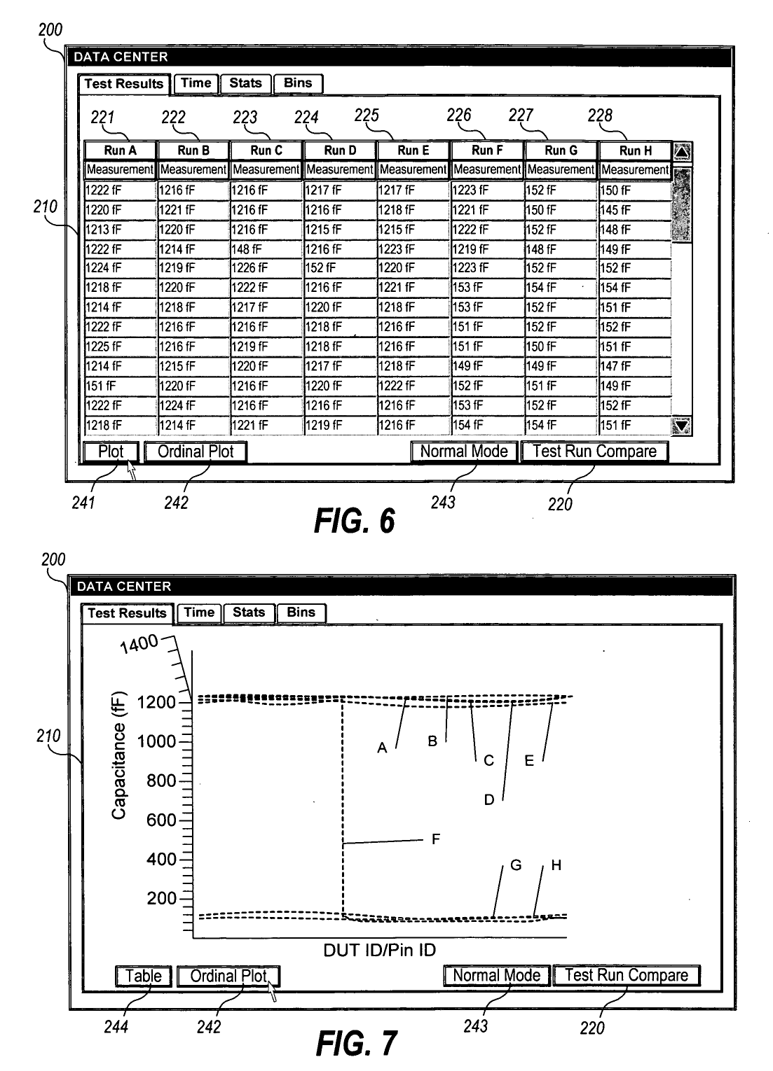

FIG. 6 illustrates the window 200 when the Test Run Comparison selections shown in FIG. 5 are applied. The GUI re-renders the screen to display a table with each selected parameter of interest (in this case, capacitance measurement) displayed side by side for each selected test run A-H. In the embodiment shown, since only one parameter of interest was selected in the dialog 230 of FIG. 4, the table includes one column for each test run (i.e., columns 221-228). If more parameters of interest had been selected (for example, x parameters), in one embodiment, the GUI would display the test run data side-by-side for each parameter. Thus, if x parameters are selected, then the display may show a table with x sets of test run data (columns A-H) for each parameter. When the test run comparison display mode is “table” mode, the window 200 may include buttons 241 and 242 which allow the operator to switch from “table” mode to either “plot” mode or “ordinal plot” mode (or other display modes). The window 200 may also display a Normal Mode button 243 which, when activated, will cause the GUI window to switch back to a single test run display (for example, such as shown in FIG. 4). The window 200 may also display a Test Run Compare button 240 which, when activated, brings up the Test Run Comparison Selection dialog 230 (of FIG. 5).

FIG. 7 illustrates the window 200 when the “Plot” button 241 is activated by the operator. In this display mode, the selected parameter data curves for each selected test run may be plotted in a graph, as shown. In the plot shown, the test run curves indicate that after a certain DUT ID/Pin ID during test run F, the tests failed for the remainder of the DUTs/Pin IDs of test run F and for all remaining test runs thereafter. This could indicates a tester failure or an external event that causes the failures. When the display mode is “plot” mode, the window 200 may include buttons 244 and 242 which allow the operator to switch from “plot” mode to either “table” mode or “ordinal plot” mode (or other display modes).

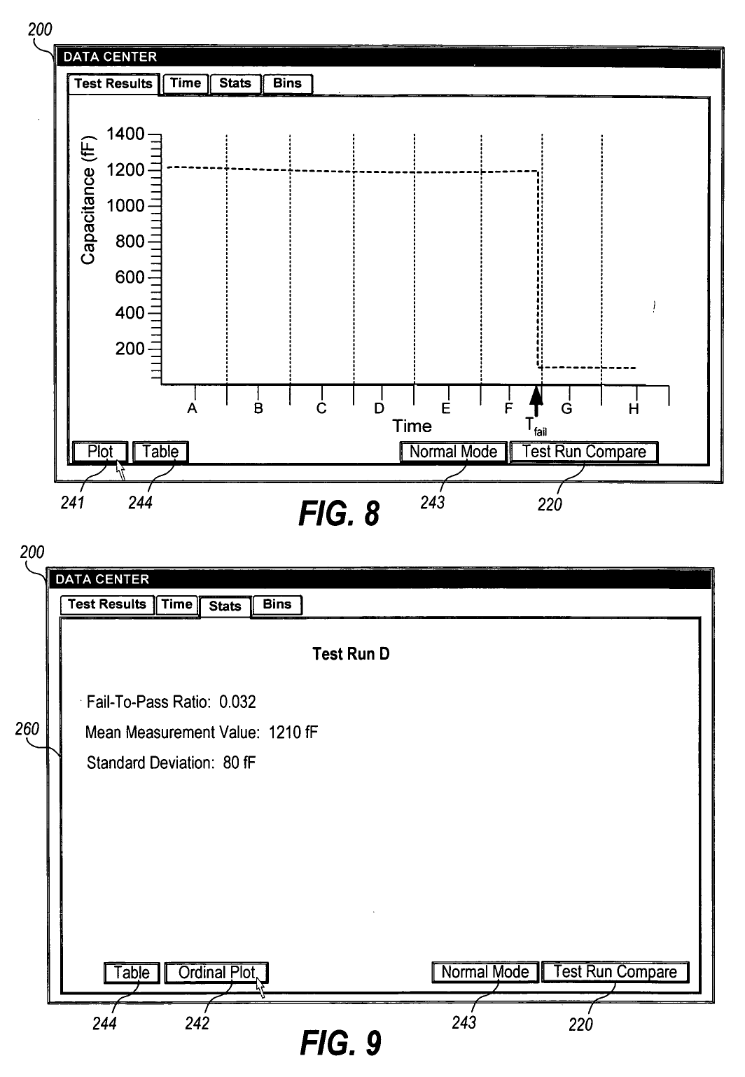

FIG. 8 illustrates the window 200 when the “Ordinal Plot” button 242 is activated by the operator. In this display mode, the selected parameter data for each selected test run is plotted as a single curve in order of time, as shown. Ordinal mode is useful for discovering “times” of significant events that affect the test data. For example, using the ordinal plot display mode, one can visually see that at time T_{fail}, some event occurred that causes all tests to subsequently fail.

In addition, ordinal mode is useful in visually presenting trends that may exist in the data. For example, suppose that as the operating temperature of the tester increases over time, more and more test failures occur. If the increase in temperature is gradual over many test runs of data, examining an individual test run's data may not reveal the failure trend even if test status is plotted against operating temperature for the individual test run. However, plotting the test status against operating temperature over the test data of multiple test runs will reveal the trend.

In some instances, viewing and comparing raw data across multiple test runs is useful, as described above. There may be other instances where it is useful to calculate statistics, and to view and compare the statistics across multiple test runs. FIG. 9 illustrates the window 200 when the Statistics tab 260 is activated by the operator. Statistics are derivations from the raw test data, for example, mean, median, and mode values of all of a test run's measurement values, standard deviation, ratio of numbers of pass status versus numbers of fail status, highest measurement value, lowest measurement value, or any other calculation that may be performed or derived from the raw test data. In the Normal Mode, the Statistics tab 260 may list a number of statistics for a given test run which may be useful to the test operator. For example, as shown in FIG. 9, the ratio of the number of failures to number of passes is shown. The mean measurement value and standard deviations are also shown.

The Statistics tab may include a Test Run Compare button 270 which, when activated, displays a Test Run Compare dialog 280 which allows comparison of statistics across multiple test runs.

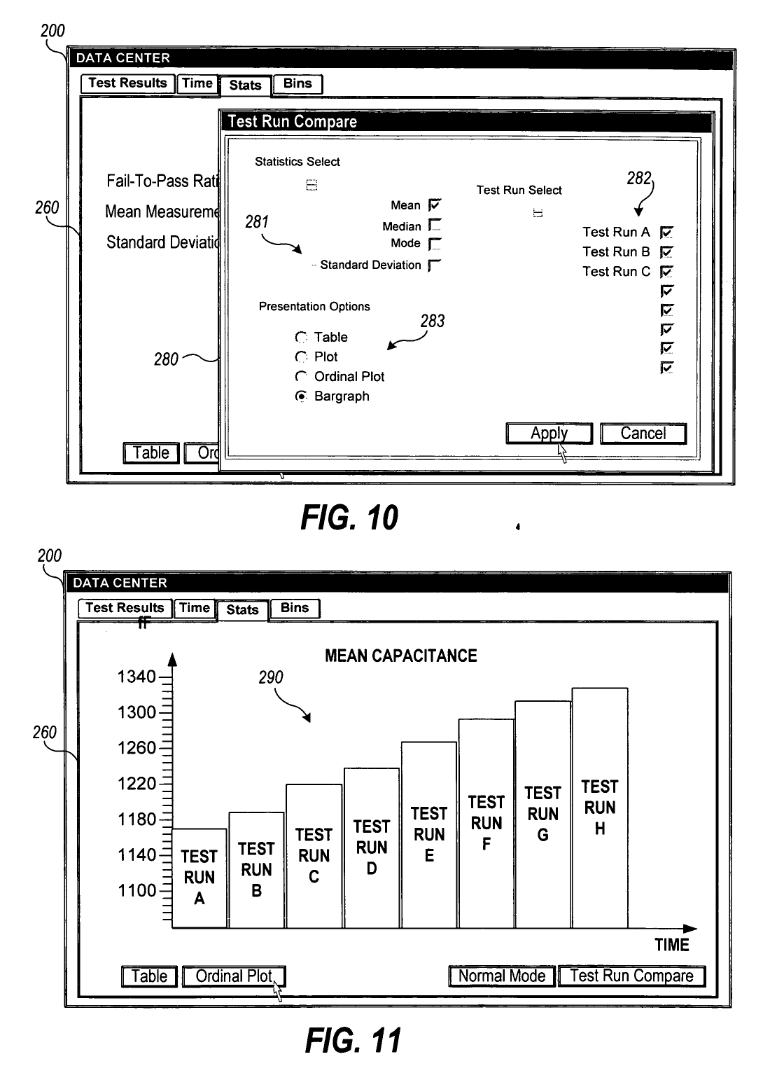

FIG. 10 shows an example Test Run Compare dialog 280 accessed from the Statistics tab 260. In the embodiment shown in FIG. 10, the Test Run Compare dialog 280 includes a statistics selection mechanism 281. The statistics selection mechanism 281 may list a number of available statistics which may be selected for comparison across test runs. The Test Run Compare dialog 280 also includes a test run selection mechanism 282 which allows the test runs to be compared to be selected. The Test Run Compare dialog 280 may also include presentation options 283 such as table, plot, ordinal plot, bargraph, etc. These presentation options 283 determine how the statistics are to be presented for comparison across test runs.

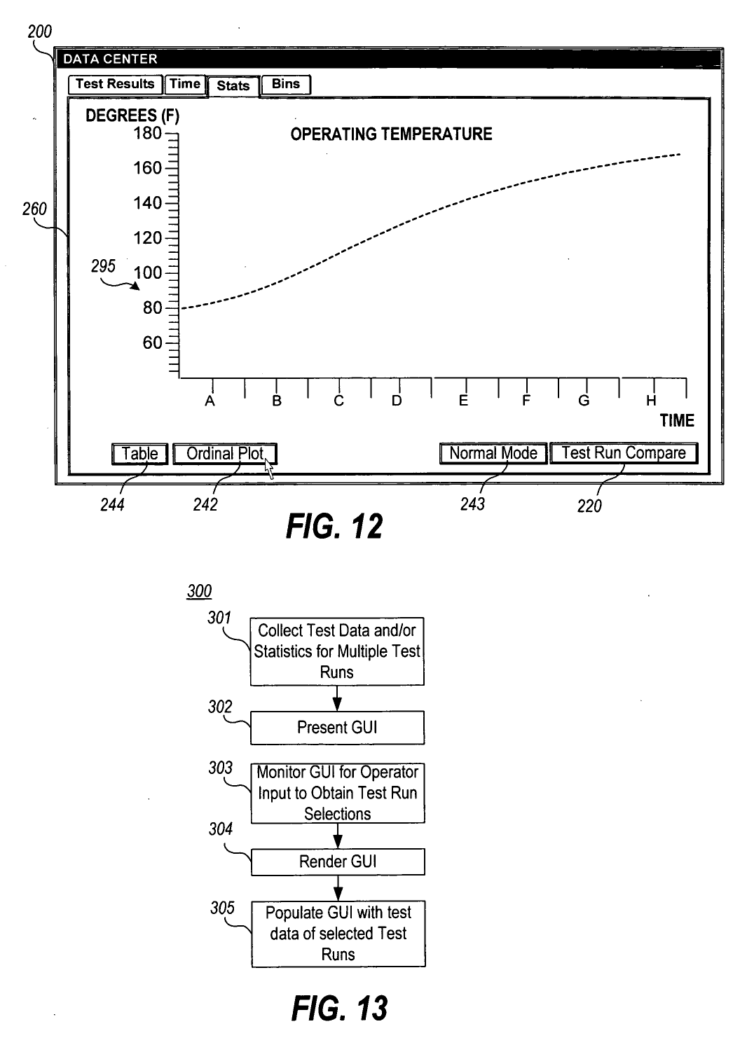

For example, suppose that the mean measurement value is selected using the statistics selection mechanism, and test runs A through H are selected using the test run selection mechanism. Suppose further that the bargraph presentation option is selected. FIG. 11 illustrates an example window which may be rendered by GUI interface when the selections shown in FIG. 10 are applied. As shown, FIG. 11 shows a bargraph 290 of the statistical mean capacitance value over test runs A through H. As shown, the statistical mean capacitance is increasing slowly from test run to test run, indicating a trend. FIG. 12 shows an ordinal plot 295 of operating temperature over test runs A through H, which shows an increase in operating temperature over time. The increase in temperature over time may correlate to the increased mean capacitance measurement over time from FIG. 11.

FIG. 13 is a flowchart illustrating an exemplary embodiment of a method 300 for simultaneously presenting, by a computer, test data associated with multiple different test runs, each test run comprising a set of tests executed by a tester on a plurality of devices under test. In this method, test data and/or statistics based on the test data are collected and stored for a plurality of test runs (step 301), wherein each test run includes the testing of a plurality of devices. A GUI is presented to a test operator (step 302). The method monitors the GUI for operator input selections of available test runs (step 303). Upon receipt of operator input test run selections (step 304), the GUI is rendered and populated with test data from the selected test runs (step 305).

Although this preferred embodiment of the present invention has been disclosed for illustrative purposes, those skilled in the art will appreciate that various modifications, additions and substitutions are possible, without departing from the scope and spirit of the invention as disclosed in the accompanying claims.

What is claimed is:

1. A test data presentation method, comprising:
simultaneously presenting, by a computer, test data associated with multiple different test runs, each test run comprising a set of tests executed by a tester on a plurality of devices under test.

2. The test data presentation method of claim 1, wherein the presenting step comprises tabulating the test data test run by test run.

3. The test data presentation method of claim 1, wherein the presenting step comprises plotting the test data in a graph.

4. The test data presentation method of claim 1, wherein the presenting step comprises plotting the test data in order of time.

5. The test data presentation method of claim 1, wherein the presenting step comprises calculating statistics based on the test data and presenting the statistics based on the test data on a test run by test run basis.

6. The test data presentation method of claim 5, wherein the presenting step comprises tabulating the statistics test run by test run.

7. The test data presentation method of claim 5, wherein the presenting step comprises plotting the statistics in a graph.

8. The test data presentation method of claim 5, wherein the presenting step comprises plotting the statistics in order of time.

9. A computer readable storage medium tangibly embodying program instructions implementing a test data presentation method, the method comprising:
simultaneously presenting, by a computer, test data associated with multiple different test runs, each test run comprising a set of tests executed by a tester on a plurality of devices under test.

10. The computer readable storage medium of claim 9, wherein the presenting step comprises tabulating the test data test run by test run.

11. The computer readable storage medium of claim 9, wherein the presenting step comprises plotting the test data in a graph.

12. The computer readable storage medium of claim 9, wherein the presenting step comprises plotting the test data in order of time.

13. The computer readable storage medium of claim 9, wherein the presenting step comprises calculating statistics based on the test data and presenting the statistics based on the test data on a test run by test run basis.

14. The computer readable storage medium of claim 13, wherein the presenting step comprises tabulating the statistics test run by test run.

15. The computer readable storage medium of claim 13, wherein the presenting step comprises plotting the statistics in a graph.

16. The computer readable storage medium of claim 13, wherein the presenting step comprises plotting the statistics in order of time.

17. A test system, comprising:
a tester which tests a plurality of devices per test run and performs a plurality of test runs;
a test data collector which collects and stores test data for the plurality of different test runs;
a test run comparison presentation function which simultaneously presents test data associated with multiple different test runs.

18. The test system of claim 17, comprising:
operator input means which allows an operator to select for test data presentation the plurality of test runs.

19. The test system of claim 17, wherein the test run comparison presentation function simultaneously presents, on a test run by test run basis, statistics derived from the test data associated with multiple different test runs.
